(19) United States
(12) Patent Application Publication
(10) Pub. No.: US 2007/0160796 A1
(43) Pub. Date: Jul. 12, 2007

(54) Optical recording media

(75) Inventor: Fung Hsu Wu, Taoyuan County (TW)

Correspondence Address: QUINTERO LAW OFFICE, PC, 2210 MAIN STREET, SUITE 200, SANTA MONICA, CA, 90405, US

(73) Assignee: DAXON TECHNOLOGY INC., TAOYUAN (TW)

(21) Appl. No.: 11/407,501

(22) Filed: Apr. 20, 2006

(30) Foreign Application Priority Data
Jan. 11, 2006 (TW) TW95101022

(51) Int. Cl. B32B 3/02

(52) U.S. Cl. 428/64.4

(57) ABSTRACT

An optical recording medium is disclosed. A substrate comprises recorded signals on a first side. A recording layer is disposed overlying the first side of the substrate. A reflective layer is disposed overlying the recording layer. A label layer disposed overlying the reflective layer, wherein the recorded signals are identical on surface of the label layer.

### BACKGROUND OF THE INVENTION

1. Field of the Invention

The present invention relates to a recording media, and in particular to an optical recording medium.

2. Description of the Related Art

Optical recording disks are widely used in data storage multimedia due to low cost, convenience of transport and non-contact reading and writing. In order to meet the requirements of digital technology and multimedia products, optical recording media with greater capacity is increasing.

Typically, a label side of an optical recording medium can be written with a marker. In addition, the label side can also be marked by a printer. Recently, in order to increase convenience and reduce cost, optical recording media can be labeled by the optical pick-up unit OPU of a CD-ROM drive.

The material of the label side of an optical recording medium is formed allows the appearance thereof to change appearance according to changes in light intensity or temperature. Therefore, optical or physical characteristics can be changed when irradiated by a laser beam from an optical pick-up unit of a CD-ROM drive. The label side of the conventional optical media, however, does not have grooves or lands. Thus, memory is required when writing, and a closed loop cannot be achieved when the optical pick-up unit is focusing and tracking. In addition, since the position of the optical pick-up unit is located according to removal length of the optical pick-up unit, instead of by feedback from the optical pick-up unit, the writing speed and accuracy are limited.

### BRIEF SUMMARY OF INVENTION

A detailed description of the invention is given in the following embodiments with reference to the accompanying drawings. These and other problems are generally solved or circumvented, and technical advantages are generally achieved, by preferred illustrative embodiments of the present invention, which provide optical recording media.

The invention provides an optical recording medium. A substrate comprises recorded signals at a first side. A recording layer is disposed overlying the first side of the substrate. A reflective layer is disposed overlying the recording layer. A label layer disposed overlying the reflective layer, wherein the recorded signals are identical on surface of the label layer.

The invention provides an optical recording medium. A substrate comprises recorded signals at a first side. A first dielectric layer is disposed overlying the first side of the substrate. A recording layer is disposed overlying the first dielectric layer. A second dielectric layer is disposed overlying the recording layer. A reflective layer is disposed overlying the second dielectric layer. A label layer is disposed overlying the reflective layer, wherein the recorded signals are identical on surface of the label layer.

The invention provides an optical recording medium. A substrate comprises recorded signals at a first side. A recording layer is disposed overlying the first side of the substrate. A reflective layer is disposed overlying the recording layer. A label layer is disposed overlying the reflective layer, wherein the label layer is substantially 30 nm˜500 nm thick.

The invention provides a method for writing symbols on a label layer of an optical recording medium. A substrate comprising recorded signals at a first side is provided, wherein a label layer is disposed overlying the first side of the substrate, and the to trace the recorded signals from the first side covered with the label layer, and symbols are written on the label layer according to the traced recorded signals.

### BRIEF DESCRIPTION OF DRAWINGS

The present invention can be more fully understood by reading the subsequent detailed description and examples with references made to the accompanying drawings, wherein:

FIG. 1 shows a cross section of a CD-R of an embodiment of the invention.

FIG. 2 shows a cross section of recording a one time use Digital Versatile Disc.

FIG. 3 shows a cross section of re-writable recording CD of an embodiment of the invention.

FIG. 4 shows a cross section of DVD-RW or DVD+RW of an embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims. Embodiments of the invention, which provides a optical recording media, will be described in greater detail by referring to the drawings that accompany the invention.

A recordable compact disk CD-R is used as an example to illustrate a method of addressing when writing labels on a label side of an optical recording medium. The invention, however, is not limited thereto. The method can be used to any recording media.

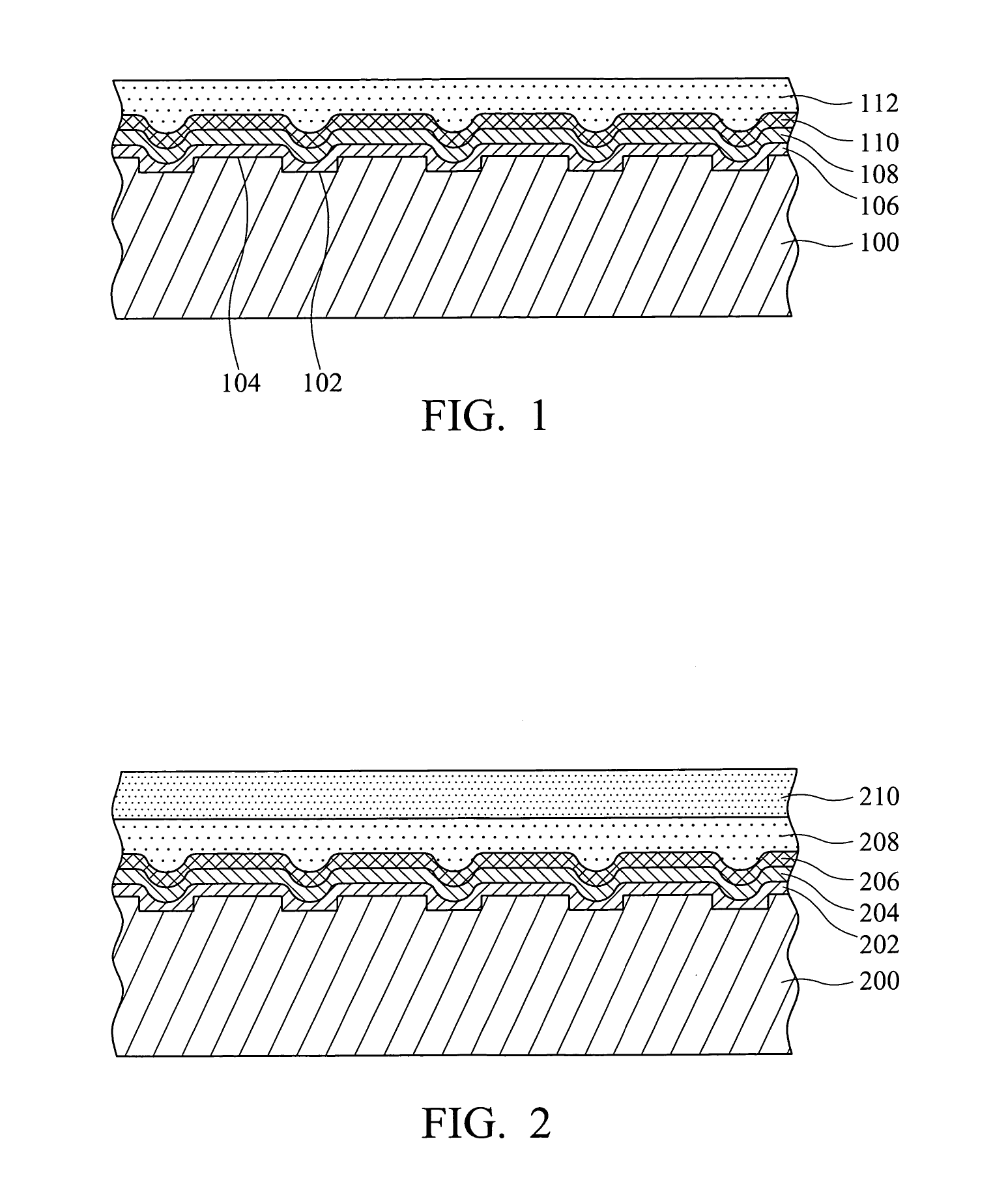

FIG. 1 shows a cross section of a CD-R of an embodiment of the invention, wherein the scale is only for reference, and is not intended to point out ratios or thicknesses provided. The substrate 100 can comprise polymer, such as polycarbonate or PMMA, and can be formed by injecting molding to a stamper comprising grooves 102. In an embodiment of the invention, the recorded signals comprise grooves 102 and lands 104. Preferably, the groove 102 depth can be substantially larger than 240 nm, and the track pitch (distance between adjacent two grooves 102) can be substantially larger than 1.6 μm. Thus, surface of a label layer formed overlying the grooves 102 in the following steps is identifiable to the recorded signals.

Next, a recording layer 106 is formed on the substrate 100. The recording layer 106 can be, for example, organic dye formed by spin coating. The thickness of the recording layer 106 is preferably 50 nm˜150 nm. Thereafter, a reflective layer 108 is formed on the recording layer 106 by, for example sputtering. The reflective layer 108 is preferably formed by materials with high reflective coefficient, such as Ag, Al, or Au. When the reflective layer 108 is Ag, the preferable thickness is 10 nm˜100 nm.

Next, a label layer 110 is formed on the reflective layer 108. In order to be capable of being written on by a writing head of a CD or DVD writer, the label layer 110 is preferably formed by materials capable of changing their optical characteristics, physical characteristics or appearance when temperature or irritating light intensity of the label layer varies. In an embodiment of the invention, the label layer 110 comprises thermochromic dyes, such as crystal violet lactone, or phase changeable materials. The label layer 110 can be formed by spin coating, sputtering or evaporation. Note that the groove 102 sizes and thicknesses of the layers, such as the recording layer 106, the reflective layer 108 and the label layer 110, thereon require fine tuning, such that the label layer 110 can have groove like features on the surface. Thus, a writing head can detect wobble signals when writing symbols on the label layer 110. Consequently, pictures and symbols can be precisely written on the label layer 110 by an optical writing head. Preferably, the label layer is thinner, preferably about 30 nm˜500 nm thick.

Next, a protective layer 112 is formed on the label layer 110 by, for example spin coating, for protection. Thus, the CD-R of an embodiment of the invention is finalized. The invention is not limited to CD-R, but is also applicable to digital versatile discs DVD.

FIG. 2 shows a cross section of recording one time use Digital Versatile Disc, such as DVD+R or DVD-R, of an embodiment of the invention. Note that the scale is only for reference, it is not intensive to point out the ratios or thicknesses of layers.

Referring to FIG. 2, a substrate 200 comprising recorded signals, such as grooves and lands, on one side is provided. The substrate 200 comprise polymer, such as polycarbonate or PMMA, which can be formed by injecting molding to a stamper, comprising grooves. The thickness of the substrate is preferably 0.6 mm˜1.2 mm.

Next, a recording layer 202 is formed on the substrate 200. The recording layer 202 can be, for example, organic dye formed by spin coating. The thickness of the recording layer 202 is preferably 50 mm˜150 nm.

Thereafter, a reflective layer 204 is formed on the recording layer 202 by, for example sputtering. The reflective layer 204 is preferably formed by materials with high reflective coefficient, such as Ag, Al, or Au. When the reflective layer 204 is Ag, the preferable thickness is 10 nm˜150 nm.

Next, a label layer 206 is formed on the reflective layer 204. In order to be capable of being written on by a writing head (or an optical pick-up unit OPU) of an optical writer, the label layer 206 is preferably formed by materials changing optical characteristics, physical characteristics or appearances when temperature or irritating light intensity of the label layer 206 varies. In an embodiment of the invention, the label layer 206 comprises dyes color with heating changeable color. The label layer preferably comprises crystal coating, sputtering or evaporation. Note that groove sizes and thicknesses of the layers, such as the recording layer 202, the reflective layer 204 and the label layer 206, thereon require fine tuning for the label layer to have groove like features on the surface. Thus, the writing head can detect wobble signals when writing symbols on the label layer 206. Consequently, pictures and symbols can be written on the label layer 206 precisely by an optical writing head.

Next, an adhesion layer 208 is formed on the label layer 206 by, for example spin coating. A top substrate 210, preferably about 0.6˜0.8 mm thick, is bonded to the label layer 206 through the adhesion layer 208 to finalize fabrication of the recording one time use DVD of the embodiment of the invention.

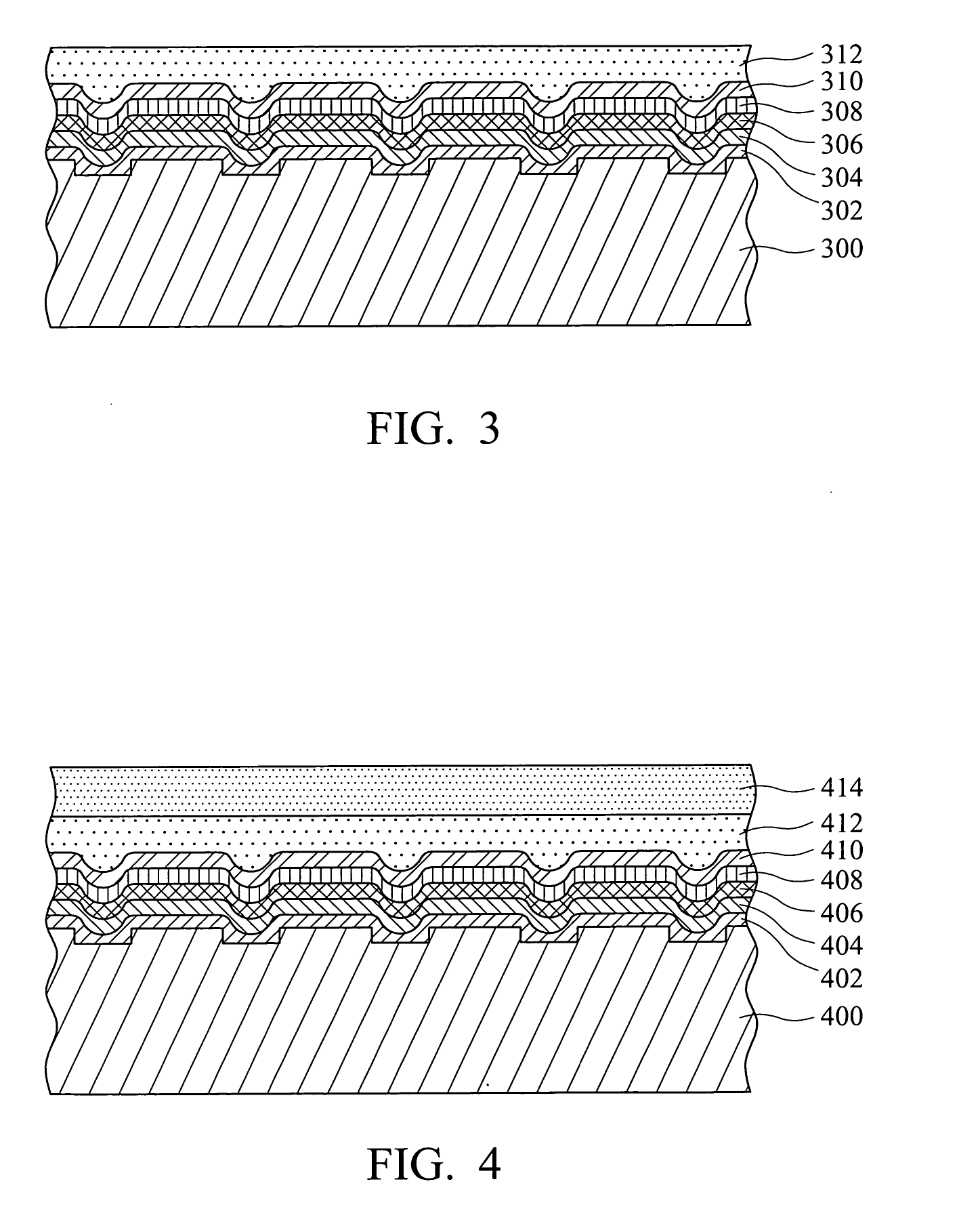

The invention, however, is not limited to recording one time use media. The feature of the invention can further be used in a re-writable recording media. FIG. 3 shows a cross section of re-writable recording CD of an embodiment of the invention. Referring to FIG. 3, a substrate 300 comprising recorded signals on one side is provided. The substrate 300 comprises polymer, such as polycarbonate or PMMA, and can be formed by injecting molding to a stamper, comprising grooves. In an embodiment of the invention, the recorded signals comprise grooves and lands.

Next, a first dielectric layer 302 is formed on the substrate 300. The first dielectric layer 302 can be SiNx, AlNx, SiOx, TaOx, ZnSx, MnSx, ZnSex or combinations thereof. The thickness of the first dielectric layer 302 dependeds upon product spec or process window. In general, the first dielectric layer 302 can be 10 nm˜200 nm thick. Next, a recording layer 304 is formed on the first dielectric layer 302. The recording layer 304 can be phase change materials, such as AgInTeSb, and preferably formed by sputtering.

Thereafter, a second dielectric layer 306 is formed on the recording layer 304. The second dielectric layer 306 can be SiNx, AlNx, SiOx, TaOx, ZnSx, MnSx, ZnSex or combinations thereof. Thickness of the second dielectric layer 306 depends upon product spec or process window. In general, the second dielectric layer 306 can be 10 nm˜200 nm thick. A reflective layer 308 is formed on the second dielectric layer 306 by, for example sputtering. The reflective layer 308 is preferably formed by materials with high reflective coefficient, such as Ag, Al, or Au.

Next, a label layer 310 is formed on the reflective layer 308. In order to be capable of being written on by a writing head of a optical writer, the label layer 310 is preferably formed by materials changing optical characteristics, physical characteristics or appearances when temperature or irritating light intensity of the label layer 310 varies. In an embodiment of the invention, the label layer 310 comprises dyes with heating changeable color. The label layer can be crystal violet lactone or phase changeable materials. The label layer 310 can be formed by spin coating, sputtering or evaporation.

Groove sizes and thicknesses of the layers, such as the first dielectric layer 302, the recording layer 304, the second dielectric layer 306, the reflective layer 308 and the label layer 310, thereon requires fine tuning for the label layer 310 to have groove like shapes. Thus, the writing head can detect wobble signals when writing pictures or texts on the label layer 310. Consequently, the optical writing head can precisely write pictures and symbols on the label layer 310.

Next, a protective layer 312 is formed on the label layer 310 by, for example spin coating, for protection. Thus, the CD-RW of an embodiment of the invention is finalized.

In addition, the invention is also applicable to rewritable DVDs. FIG. 4 shows a cross section of DVD-RW or DVD+RW of an embodiment of the invention. Referring to FIG. 4, a substrate 400 comprising recorded signals on one side is provided. The substrate injection molding to a stamper, comprising grooves. In an embodiment of the invention, the recorded signals comprise grooves and lands.

Next, a first dielectric layer 402 is formed on the substrate 400. The first dielectric layer 402 can be SiNx, AlNx, SiOx, TaOx, ZnSx, MnSx, ZnSex or combinations thereof. Thickness of the first dielectric layer 402 depends upon product spec or process window. In general, the first dielectric layer 402 can be 10 nm˜200 nm thick. Next, a recording layer 404 is formed on the first dielectric layer 402. The recording layer 404 can be phase change materials, such as AgInTeSb, and preferably formed by sputtering.

Thereafter, a second dielectric layer 406 is formed on the recording layer 404. The second dielectric layer 406 can be SiNx, AlNx, SiOx, TaOx, ZnSx, MnSx, ZnSex or combinations thereof. The thickness of the second dielectric layer 406 depends upon product spec or process window. The second dielectric layer 406 can be 10 nm˜200 nm thick. A reflective layer 408 is formed on the recording layer 404 by, for example, sputtering. The reflective layer 408 is preferably formed by materials with high reflective coefficient, such as Ag, Al, or Au.

Next, a label layer 410 is formed on the reflective layer 408. In order to be capable of be written on by a writing head of a optical writer, the label layer 410 is preferably formed by materials changing optical characteristics, physical characteristics or appearances when temperature or irritating light intensity of the label layer varies. In an embodiment of the invention, the label layer 410 comprises dyes with heating changeable color. For example, the dyes can be crystal violet lactone, or phase changeable materials. The label layer 410 can be formed by spin coating, sputtering or evaporation.

Note that the groove sizes and thicknesses of layers, such as the first dielectric layer 402, the recording layer 404, the second dielectric layer 406, the reflective layer 408 and the label layer 410, thereon requires fine tuning the label layer to have groove like features. Thus, the writing head can detect wobble signals when writing symbols on the label layer 410. Consequently, pictures and symbols can be precisely written on the label layer 410 by an optical writing head.

Next, an adhesion layer 412 is formed on the label layer 410 by, for example spin coating. A top substrate 414 is bonded to the label layer 410 through the adhesion layer 412. Thickness of the top substrate 414 is preferably 0.6˜0.8 mm. Thus, the DVD+RW or DVD-RW of the embodiment is finalized.

According to an embodiment described, the recording media is identical to the label side. Thus, an optical writer can precisely and quickly obtain real-time addressing signals when writing symbols on the label layer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical recording medium, comprising:
a substrate, comprising recorded signals on a first side;
a recording layer disposed overlying the first side of the substrate;
a reflective layer disposed overlying the recording layer; and
a label layer disposed overlying the reflective layer, wherein the recorded signals are identical on the surface of the label layer.

2. The optical recording medium as claimed in claim 1, wherein the recorded signals comprise grooves and lands arranged in a spiral.

3. The optical recording medium as claimed in claim 1, wherein depth of the groove is substantially larger than 240 nm.

4. The optical recording medium as claimed in claim 1, wherein a pitch between adjacent grooves is substantially larger than 1.6 μm.

5. The optical recording medium as claimed in claim 1, wherein the label layer is substantially 30 nm˜500 nm thick.

6. The optical recording medium as claimed in claim 1, wherein the label layer is formed by materials that can change their optical characteristics, physical characteristics or appearances when the temperature or irritating light intensity of the label layer varies.

7. The optical recording medium as claimed in claim 1, wherein the label layer comprises thermochromic dyes or phase change materials.

8. The optical recording medium as claimed in claim 1, further comprising a protective layer on the label layer.

9. The optical recording medium as claimed in claim 1, further comprising an adhesion layer on the label layer and a top substrate on the adhesion layer.

10. The optical recording medium as claimed in claim 1, wherein the reflective layer is substantially 10 nm˜100 nm thick.

11. An optical recording medium, comprising:
a substrate, comprising recorded signals on a first side;
a first dielectric layer disposed overlying the first side of the substrate;
a recording layer disposed overlying the first dielectric layer;
a second dielectric layer disposed overlying the recording layer;
a reflective layer disposed overlying the second dielectric layer; and
a label layer disposed overlying the reflective layer, wherein the recorded signals are identical on surface of the label layer.

12. The optical recording medium as claimed in claim 11, wherein the recorded signals comprise grooves and lands arranged in a spiral.

13. The optical recording medium as claimed in claim 11, wherein depth of the groove is substantially larger than 240 nm.

14. The optical recording medium as claimed in claim 11, wherein a pitch between adjacent grooves is substantially larger than 1.6 μm.

15. The optical recording medium as claimed in claim 11, wherein the label layer is substantially 30 nm˜500 nm thick.

16. The optical recording medium as claimed in claim 11, wherein the label layer is formed by materials that can change their optical characteristics, physical characteristics or appearances when the temperature or irritating light intensity of the label layer varies.

17. The optical recording medium as claimed in claim 11, wherein the label layer comprises thermochromic dyes or phase change materials.

18. The optical recording medium as claimed in claim 11, further comprising a protective layer on the label layer.

19. The optical recording medium as claimed in claim 11, further comprising an adhesion layer on the label layer and a top substrate on the adhesion layer.

20. An optical recording medium, comprising:
a substrate, comprising recorded signals at a first side;
a recording layer disposed overlying the first side;
a reflective layer disposed overlying the recording layer; and
a label layer disposed overlying the reflective layer, wherein the label layer is substantially 30 nm˜500 nm thick.

21. The optical recording medium as claimed in claim 20, wherein the label layer is formed by materials that can change their optical characteristics, physical characteristics or appearances when the temperature or irritating light intensity of the label layer varies.

22. A method for writing symbols on a label layer of an optical recording medium, comprising:
providing a substrate comprising recorded signals at a first side, a label layer disposed overlying the first side of the substrate, wherein the recorded signals are identical on surface of the label layer; and
using an optical pick-up unit to trace the recorded signals from the first side covered with the label layer, and writing symbols on the label layer according to the traced recorded signals.

23. The method as claimed in claim 22, wherein the optical pick-up unit is a writing head of an optical writer.

24. The method as claimed in claim 22, wherein the label layer is formed by materials that can change their optical characteristics, physical characteristics or appearances when the temperature or irritating light intensity of the label layer varies.

25. The method as claimed in claim 22, wherein the label layer is substantially 30 nm˜500 nm thick.

26. The method as claimed in claim 22, wherein the optical recording medium is a disk.

27. The method as claimed in claim 22, wherein the recorded signals comprise grooves and lands arranged in a spiral.
